(19) United States
(12) Patent Application Publication
(10) Pub. No.: US 2014/0146586 A1
(43) Pub. Date: May 29, 2014

(54) MULTILEVEL CONVERTER AND METHOD OF STARTING UP A MULTILEVEL CONVERTER

(71) Applicant: SIEMENS AKTIENGESELLSCHAFT, Munchen (DE)

(72) Inventors: Anandarup Das, Trondheim (NO); Hamed Nademi, Trondheim (NO); Lars Norum, Trondheim (NO)

(21) Appl. No.: 14/111,984

(22) PCT Filed: Apr. 10, 2012
(86) PCT No.: PCT/EP2012/056440

§ 371 Date: Feb. 10, 2014

(30) Foreign Application Priority Data
Apr. 15, 2011 (EP) 11162659.4

(51) Int. Cl. H02M 7/68; H02M 1/36

(52) U.S. Cl. CPC H02M 7/68; H02M 1/36
USPC 363/49; 363/13; 320/166

(57) ABSTRACT

A multilevel converter for converting between an AC voltage and a DC voltage and a method of starting up such multilevel converter are provided. The multilevel converter has an AC terminal and a DC terminal for connecting the multilevel converter to either an AC power source or a DC power source, respectively, which supplies the voltage to be converted. The multilevel converter further comprises at least one converter leg, the DC terminal comprising a first and a second DC terminal, the converter leg comprising plural converter cells connected in series between the first and second DC terminals. The AC terminal of the multilevel converter is electrically coupled to an electrical link between two of said converter cells of said converter leg.

### FIELD OF THE INVENTION

The invention relates to a multilevel converter and to a method of starting up a multilevel converter. In particular, it relates to the charging of a capacitor of a converter cell of a multilevel converter.

### BACKGROUND OF THE INVENTION

Multilevel converters are now frequently being employed for converting between an AC (alternating current) voltage and a DC (direct current) voltage. Such converters provide different voltage levels by which an AC voltage can for example be synthesized. The converter may further use a pulse width modulation (PWM) technique in the generation of the AC voltage. The use of different voltage levels at the AC output further reduces the required switching frequency for PWM.

The Modular Multilevel Converter (MMC) is a promising multilevel converter topology proposed in recent times. Such converter has a modular structure, which may provide redundant cells for fault tolerant applications and an easy scalability. A MMC can comprise a number of converter cells in series. Each cell can have of two switches and a capacitor. When one of the switches is turned on, the capacitor is bypassed and the output voltage of the converter cell is zero. When the other switch is turned on, the capacitor voltage is obtained at the output. With many cells connected in series, the output voltage of the converter can be made smooth and no or very minimal filtering is required to improve the output voltage quality.

The starting up such converter, e.g. from a de-energized state in which the capacitors of the converter cells are substantially discharged, is generally difficult. A ‘black start’ of the converter for reaching the operation conditions may be performed by using an auxiliary voltage source having an output voltage similar to the nominal voltage of the capacitor of a converter cell in order to individually charge each of the capacitors of the plurality of converter cells. Such procedure may be time consuming and requires an additional auxiliary voltage source.

### SUMMARY

Accordingly, there is a need to improve the start-up of a multilevel converter, in particular to improve the charging of a capacitor of a converter cell of the multilevel converter.

This need is met by the features of the independent claims. The dependent claims describe embodiments of the invention.

An aspect of the invention relates to a multilevel converter for converting between an AC voltage and a DC voltage. The multilevel converter has an AC terminal and a DC terminal for connecting the multilevel converter to either an AC power source or a DC power source, respectively, which supplies the voltage to be converted. The multilevel converter comprises at least one converter leg. The DC terminal comprises a first and a second DC terminal, the converter leg comprising plural converter cells connected in series between the first and second DC terminals. The AC terminal of the multilevel converter is electrically coupled to an electrical link between two of the converter cells of said converter leg. The multilevel converter further comprises a resistor circuit comprised in said converter leg and connected in series with the converter cells. The resistor circuit is configured so as to be capable of connecting a resistance in series with the converter cells of the converter leg. Each converter cell comprises a capacitor. The multilevel converter is configured so as to enable a charging of the capacitor of a converter cell from the power source connected to the AC terminal or the DC terminal of the multilevel converter through the resistance of the resistor circuit.

With such configuration, the capacitors of the converter cells may be charged at startup directly from the main power source (or operating power source), i.e. from the AC power source or the DC power source which supplies the electrical power to be converted during operation of the multilevel converter. No auxiliary power source is thus needed for charging the capacitors of the converter cells at start-up. The start-up of the multilevel converter may thus be facilitated and accelerated.

In an embodiment, the resistor circuit comprises the resistance connected in series with the converter cells. It may further comprise a switch connected in parallel with the resistance so as to enable a bypassing of the resistance by closing the switch. An efficient way of inserting the resistance into the converter leg circuit and of removing it therefrom is thus provided.

Other configurations, in which the resistor circuit may for example comprise an adjustable resistance that can be adjusted to a value of about zero, are also conceivable.

The switch may be a mechanical switch, an electronic switch or a semiconductor switch. The switch may be operated by a controller.

The resistor circuit may be connected between a converter cell and the electrical link towards which the AC terminal is coupled.

In an embodiment, the converter leg may comprise a first converter arm comprising the converter cells coupled between the first DC terminal and the electrical link, and a second converter arm comprising the converter cells coupled between the second DC terminal and the electrical link. The resistor circuit may be comprised in the first converter arm. The second converter arm may further comprise a second resistor circuit connected in series with the converter cells of the second converter arm. The resistance provided by the resistor circuit may thus be controlled individually for each converter arm.

The second resistor circuit may be substantially similar to the first resistor circuit.

The multilevel converter may operate as a rectifier that is supplied with a one phase or three phase AC voltage via the AC terminal and generates a DC voltage on the DC terminals. It may also operate as an inverter that generates from a DC voltage supplied to the DC terminals a one phase or three phase AC voltage.

In an embodiment, the at least one converter leg may comprise three converter legs, each converter leg being coupled to an AC terminal for supplying or receiving an AC voltage of a different phase. The multilevel converter can be configured to convert to or from a three phase AC voltage.

The multilevel converter may be adapted so as to be capable of discharging the capacitor of a converter cell through the resistance of the resistor circuit. The multilevel converter may thus be brought safely into a de-energized state.

The multilevel converter may further comprise a switch to connect the AC terminal of a first of the converter legs to a second AC terminal of a second of the converter legs so as to enable the discharging of the capacitor through at least part of the first and the second converter legs. When power source and load are disconnected from the multilevel converter, it may thus safely be brought into the de-energized state without requiring auxiliary equipment.

The converter leg may further comprise an inductance connected in series with the converter cells. A smooth output voltage may thus be obtained.

In an embodiment, the converter leg further comprises an inductance connected in series with the converter cells, the resistance of the resistor circuit being configured such that the series connection of the inductance, the resistance and the capacitor of one converter cell or of the converter cells connected between the first or second DC terminal and the electrical link provide an overdamped system. Overshoot, in particular overcurrents may thus be avoided when the capacitor of the converter cell is charged from the main AC or DC power supply.

Each converter cell may comprise two terminals by which the converter cell is connected in series with the other converter cells in the converter leg. The converter cell may comprise a first switch and a second switch. The second switch can be connected in series with the capacitor of the converter cell. The first switch can be connected in parallel with the capacitor and the second switch of the converter cell. Thus, by closing the first switch, the second switch and the capacitor may be bypassed. The capacitor of the converter cell may thus efficiently be inserted or taken out of the circuitry of the converter leg.

The switches may be semiconductor switches. The switches may be selected from a group comprising an insulated gate bipolar transistor (IGBT), a power MOSFET, a power thyristor (like a SCR, a GTO, a MCTs or the like), and a bipolar junction transistor (BJT).

In an embodiment, the converter leg comprises a first converter arm comprising the converter cells coupled between the first DC terminal and the electrical link and a second converter arm comprising the converter cells coupled between the second DC terminal and the electrical link. The multilevel converter may be configured so that by closing all first switches of the converter cells in the second converter arm and by opening all first switches and closing all second switches of the converter cells in the first converter arm, the capacitor of each converter cell in the first converter arm is charged. As all capacitors of the converter arm can be charged simultaneously, the charging process can be further accelerated and simplified. Note that the configuration may be such that a similar charging of the capacitors in the second converter arm is enabled, e.g. by exchanging the switching state of the switches of the first and second converter arms.

As the cells are connected in series, the capacitors of the cells of a converter arm can be connected in series as well. The multilevel converter can thus be configured so that by applying a voltage to a converter arm, each capacitor in the converter arm is charged by said voltage divided by the number of capacitors connected in series in the converter arm. The applied voltage is for example the DC voltage of the DC power source provided at the DC terminal.

Charging may also occur by the AC voltage of an AC power source provided at the AC terminal. The multilevel converter may for example be configured such that the one or more capacitors are connected into the converter leg for charging during a particular phase of the waveform of the AC voltage, e.g. during the positive leading edge of the AC voltage waveform.

In other embodiments, the multilevel converter may comprise sensors for determining the charging state of the capacitors of the converter cells. The multilevel converter may then be configured so as to control the charging of each capacitor to a predetermined voltage level. For example when charging from an AC power source, the AC voltage of which has due to the AC waveform varying voltage levels, it becomes possible to still charge each capacitor to the desired voltage level. The capacitor may for example be taken out of the converter arm/leg by means of the above mentioned switches when the desired charging state is reached.

The first and second converter arms may comprise the same number of converter cells. Each converter arm may comprise one of the above mentioned resistor circuits. The converter arms may be symmetric with respect to the resistor circuit and an inductance which can be provided in series connection in the converter arm.

In an embodiment, the multilevel converter may further comprise for each DC terminal a switch (or breaker) for disconnecting the respective DC terminal from a DC power source or a load. It may further comprise for each AC terminal a switch (or breaker) for disconnecting the respective AC terminal from an AC power source or a load. The power source and the load may thus be disconnected from the converter, so as to enable the de-energizing of the converter, e.g. by discharging the capacitors of the converter cells. For starting up the converter, the power source may first be connected, the switches of the converter cells may be set in the above described manner for charging the capacitors, thereby energizing the converter. The load may after charging be connected to the converter, and the operation of the converter can be started.

The load may for example be a drive, and the multilevel converter may convert the electrical power provided by the power source to the electrical power required for operating the drive. The power source may for example be a DC bus, the converter converting the DC voltage into an AC voltage for operating an AC electrical motor of a drive. In other applications, the multilevel converter may be connected between different types of power grids. It may convert an AC voltage provided by an AC power grid into a DC voltage for DC electric power transmission, such as HVDC (high voltage DC).

In an embodiment, the multilevel converter may be a modular multilevel converter (MMC), and the converter cells may be converter modules of the modular multilevel converter.

Another aspect of the invention relates to a method of starting up a multilevel converter. The multilevel converter is adapted to convert between an AC voltage and a DC voltage, the multilevel converter having an AC terminal and a DC terminal for connecting the multilevel converter to either an AC power source or a DC power source, respectively, which supplies the voltage to be converted. The multilevel converter comprises a converter leg with plural converter cells connected in series. Each converter cell comprises a capacitor. The method comprises the steps of supplying electric power of the AC power source or the DC power source to the converter leg, connecting a resistance in series with the converter cells, and connecting the capacitor of one or more converter cells in series with the resistance. This is performed such that the one or more capacitors connected in series with the resistance are charged from the connected power source through the resistance.

With the method, similar advantages as the ones outlined above with respect to the multilevel converter may be achieved. In particular, the one or more capacitors can be charged directly from the main power source, so that no auxiliary power source is required. Note that the order of the method steps can be changed, i.e. the resistor and capacitor may first be connected in series whereafter the electric power is supplied to the converter leg.

In an embodiment, the step of connecting the capacitor of one or more converter cells in series with the resistance so as to charge the one or more capacitors through the resistance is repeated until the capacitor of each converter cell in the converter leg is charged.

In some embodiments, each capacitor may be individually connected in series with the resistance and charged therethrough, i.e. one after the other. In other embodiments, plural capacitors may be connected in series with the resistance and charged simultaneously. As outlined above, a feedback system determining the charging state of each capacitor may be provided so that each capacitor can be charged to a predetermined voltage level. This is particularly advantageous when charging from an AC power source.

In an embodiment, the converter leg may comprise a first converter arm comprising the converter cells coupled between the first DC terminal and the electrical link and a second converter arm comprising the converter cells coupled between the second DC terminal and the electrical link. The step of connecting the capacitor of one or more converter cells in series with the resistance may comprise connecting the capacitor of each converter cell in the first or the second converter arm in series with the resistance, so that each of the capacitors of the respective converter arm is charged through the resistance from the AC power source or the DC power source. This can for example be performed for the first converter arm and subsequently for the second converter arm, so that with two charging operations, each of said capacitors in the converter leg can be charged.

The electrical link at which the AC terminal is connected can be the electrical link between the first and the second converter arms. Each converter arm can comprise one of the above mentioned resistor circuits for connecting the resistance in series with the converter cells of each arm. The capacitors may be charged through the resistances of both resistor circuits in the converter leg.

The multilevel converter may comprise further converter legs, e.g. three converter legs for providing/receiving three phase AC electrical power. Each converter leg can be configured as outlined above, with two converter arms and one or two resistor circuits.

For discharging a capacitor, the capacitor can be connected in series with the converter cells and the electrical links of two converter legs can be connected to each other, so that the capacitor is discharged through the two first converter arms or the two second converter arms of the two converter legs (in dependence on in which arm the capacitor is located).

In an embodiment, a predetermined DC voltage is supplied by a DC power source or is to be supplied to a DC load at the DC terminal of the multilevel converter. The converter leg may comprise a first converter arm comprising the converter cells coupled between the first DC terminal and the electrical link and a second converter arm comprising the converter cells coupled between the second DC terminal and the electrical link. For each converter arm, the capacitor of each converter cell of the converter arm can be charged to a voltage that is about equal to the predetermined DC voltage divided by the number of converter cells comprised in the respective converter arm. With n converter cells in each converter arm, each capacitor may for example be charged up to a voltage of V_{dc}/n, wherein V_{dc} is the predetermined voltage between the first and second DC terminals. This charging level may be suitable for starting the operation of the multilevel converter.

In a further embodiment, the at least one converter leg comprises a first converter leg for a first phase of the AC voltage and a second converter leg for a second phase of the AC voltage, the first and second converter legs being connected in parallel between the first and second DC terminals of the multilevel converter. The method may further comprise connecting a first phase of the AC power supply to the AC terminal of the first converter leg and connecting a second phase of the AC power supply to an AC terminal of the second converter leg, connecting the capacitor of at least one converter cell of the first converter leg between one DC terminal and an AC terminal of the first converter leg, connecting the resistance of the first converter leg in series with the capacitor of the at least one converter cell, and providing an electrical connection between the AC terminal of the second converter leg and said DC terminal by means of the second converter leg. This is performed such that the at least one capacitor is charged from the AC power source via at least part of the first and second converter legs. At least part of the second converter leg may thus function as a ‘return path’ for the AC voltage supplied to the first converter leg.

In other embodiments, the method may comprise further steps, such as disconnecting the load from the multilevel converter before connecting power supply thereto, i.e. before charging, or removing the resistance from the series connection with the converter cells and connecting a load to the multilevel converter after the one or more capacitors were charged.

Another aspect of the invention provides a method of discharging the capacitors of a multilevel converter, the multilevel converter being adapted to convert between an AC voltage and a DC voltage, the multilevel converter comprising at a first and a second converter leg each being connected between a first DC terminal and a second DC terminal of the multilevel converter, wherein each the converter legs comprises plural converter cells connected in series between the first and second DC terminals, and wherein each converter cell comprising a capacitor. The method comprises the steps of disconnecting the power source and a load from the multilevel converter, connecting the capacitor of a converter cell comprised in one of the converter legs in series with the converter cells of the converter leg, connecting a resistance in series with the capacitor of the converter cell, and providing an electrical connection between the first and second converter legs such that the capacitor is discharged through the resistance, at least a part of the first and second converter legs, one of said (disconnected) DC terminals and said electrical connection.

By connecting the resistance in series with the capacitor, discharging of the capacitor is facilitated and can be performed by simple switching operations. No auxiliary equipment is necessary to discharge the capacitor. The multilevel converter can thus safely be brought into a de-energized state.

The method may be carried out by the above described multilevel converter or embodiments thereof. In particular, connecting the resistance in series with the capacitor of a converter cell may be performed by the above mentioned resistor circuit.

The features of the aspects and embodiments of the invention mentioned above and those yet to be explained below can be combined with each other unless noted to the contrary.

In particular, the above described methods may be performed by embodiments of the multilevel converter. Also, the multilevel converter may be adapted so as to perform any of the methods described above or embodiments of these.

### BRIEF DESCRIPTION OF THE DRAWINGS

The foregoing and other features and advantages of the invention will become further apparent from the following detailed description read in conjunction with the accompanying drawings.

In the drawings, like reference numerals refer to like elements.

FIG. 1 is a schematic diagram illustrating a multilevel converter.

FIG. 2 is a schematic diagram illustrating the configuration of a converter cell that may be used in embodiments of the invention.

FIGS. 3A and 3B are schematic diagrams of a multilevel converter according to an embodiment of the invention.

FIG. 4 is a schematic diagram illustrating the multilevel converter of FIG. 3 in a state in which the capacitors of a converter arm are charged simultaneously.

FIG. 5 is a schematic diagram illustrating a multilevel converter according to an embodiment of the invention in a state in which the capacitor of a converter cell is discharged.

FIG. 6 is a schematic diagram illustrating a multilevel converter according to an embodiment of the invention in a state in which the capacitor of a converter cell is charged from an AC power source.

FIG. 7 is a diagram illustrating a peak current in a converter arm during charging in dependence on a damping factor that is adjustable by the resistance.

FIGS. 8a and 8b are diagrams illustrating the subsequent charging of capacitors of converter cells of a multilevel converter in accordance with an embodiment of the invention.

FIGS. 9a and 9b are diagrams illustrating the simultaneous charging of the capacitors of the converter cells of a converter arm of a multilevel converter in accordance with an embodiment of the invention.

FIG. 10 is a flow diagram illustrating a method according to an embodiment of the invention.

### DETAILED DESCRIPTION

In the following, the embodiments illustrated in the accompanying drawings are described in more detail. It should be clear that the following description is only illustrative and non restrictive. The drawings are only schematic representations, and elements in the drawings are not necessarily to scale with each other. Connections between elements illustrated in the drawings may be direct or indirect couplings, e.g. couplings with one or more intervening elements.

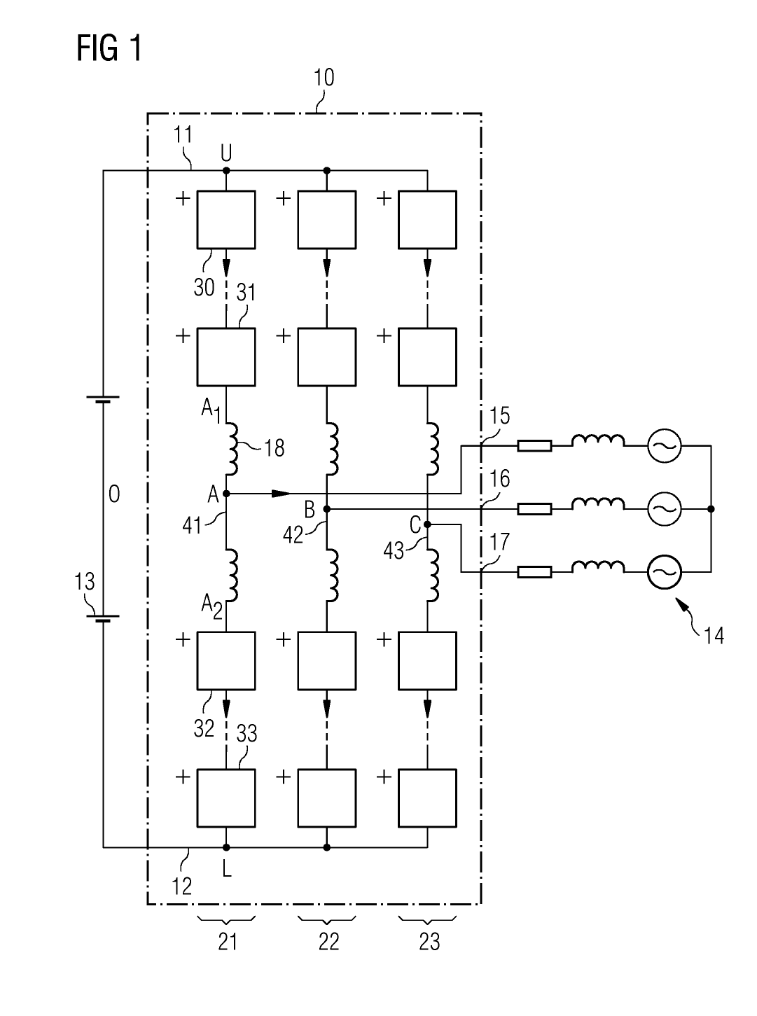

FIG. 1 illustrates a multilevel converter 10, which is adapted to convert between an AC voltage and a DC voltage. Multilevel converter 10 comprises a first DC terminal 11 and a second DC terminal 12 for connecting to a DC power source 13 or to a load requiring a DC electrical power. Via terminals 11 and 12, the multilevel converter 10 may for example be connected to DC transmission line for a HVDC (high voltage DC) transmission of electrical energy.

On the AC side of the multilevel converter 10, AC terminals 15, 16 and 17 are provided for connecting a three phase AC power source or for supplying three phase AC power to an AC load, such as an AC motor or the like. In other configurations, only one AC terminal for supplying or receiving a single phase AC voltage may be provided. When a DC power source is connected to the DC terminals 11 and 12 and an AC load is connected to the terminals 15, 16 and 17, the multilevel converter 10 operates as an inverter. Vice versa, when an AC power source is connected to AC terminals 15, 16 and 17 and a DC load is connected to the DC terminals 11 and 12, the multilevel converter 10 operates as a rectifier.

In the multilevel converter illustrated in FIG. 1, three converter legs 21, 22 and 23 are connected in parallel between the DC terminals 11 and 12. Each converter leg comprises a number of converter cells 30, 31, 32, 33 which are connected in series between the first DC terminal 11 and the second DC terminal 12. As indicated by the dots, each converter leg may comprise further converter cells that can be connected in series. The converter cells can be provided as modules, and the multilevel converter 10 can be a modular multilevel converter (MMC). Such modular structure enables scalability and provides a certain redundancy of the converter cells which may be used for fault tolerant applications. It should be clear that the multilevel converter 10 may comprise further converter legs, or may comprise only one or two converter legs.

The AC terminals 15, 16 and 17 are connected to the converter legs 21, 22 and 23 at the electrical links 41, 42 and 43 between adjacent converter cells. For example in converter leg 21, the electrical link 41 provides an electrical connection between the converter cells 31 and 32. AC terminal 15 is connected to the electrical link 41. The upper part of the converter leg (above the electrical link) can be termed upper converter arm and the lower part of the converter leg can be termed lower converter arm.

In each converter arm, an inductance 18 is furthermore provided. In the example of FIG. 1, the inductance is connected between the electrical link towards which the AC terminal is coupled and a converter cell. In other configurations, the inductance may be connected at a difference position in the respective converter arm.

The general description of the multilevel converter 10 given above is applicable to any of the embodiments described further below, i.e. embodiments of the multilevel converter 10 described below may be configured similarly.

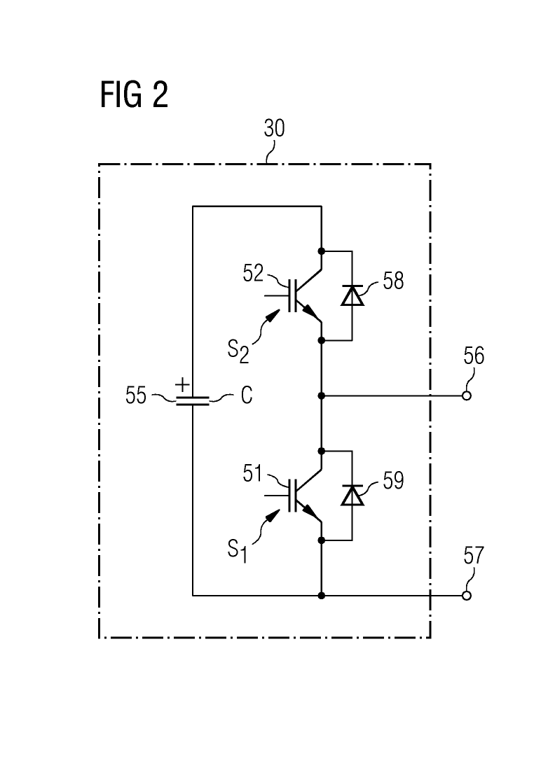

FIG. 2 illustrates an embodiment of a converter cell 30 which may be used with any of the embodiments of the multilevel converter 10 described herein. Each of the converter cells 30, 31, 32, 33 and the other converter cells of the multilevel converter may be configured as illustrated in FIG. 2. Converter cell 30 comprises a first switch (S1) 51 and a second switch (S2) 52 and a capacitor 55. Switches S1 and S2 may be semiconductor switches, in particular IGBTs, power MOSFETs, power thyristors or the like. Diodes 58 and 59 are furthermore coupled to the switches 51 and 52.

The converter cell 30 is connected in series with the other converter cells of the converter leg using the terminals 56 and 57. By means of the switches S1 and S2, the voltage at the terminals of the converter cell 30 can be switched to either zero volt or to the voltage to which the capacitor 55 is charged. When switch S1 is turned on, the capacitor is bypassed and the output voltage of the cell is zero. When S2 is closed, the capacitor voltage is obtained at the terminals. By connecting several cells in series in the converter arm, the output voltage of the converter arm can be adjusted to different voltage levels. Thus, at the AC terminal connected to the converter leg, different output voltages can be obtained, and can be adjusted so as to obtain a smooth alternating voltage that requires no or only a small about of filtering to improve the output voltage quality.

Each converter cell 30 may furthermore comprise a control interface for controlling the switches S1 and S2 and for obtaining information on the status, in particular the charging state of the capacitor 55. Such information may be obtained by a voltage sensor. As an example, a bidirectional fiber optic interface may be provided in addition to the electric terminals 56 and 57. Thus, by means of corresponding control software controlling the switches S1 and S2, the charging level of capacitor 55 can be controlled during the operation of the multilevel converter, and accordingly, the voltage supplied by the converter cell 30 can be controlled for generating the required AC output voltage.

Converter cell 30 may be a converter module (or may be termed submodule), and converter 10 may be a modular multilevel converter. In particular, the converter 10 may be configured and operated as described in the publication “An innovative modular multilevel converter topology suitable for a wide power range” by A. Lesnicar and R. Marquardt, in Proc. of IEEE Power Tech Conf. 2003, pp. 1-6, which is incorporated herein by reference in its entirety.

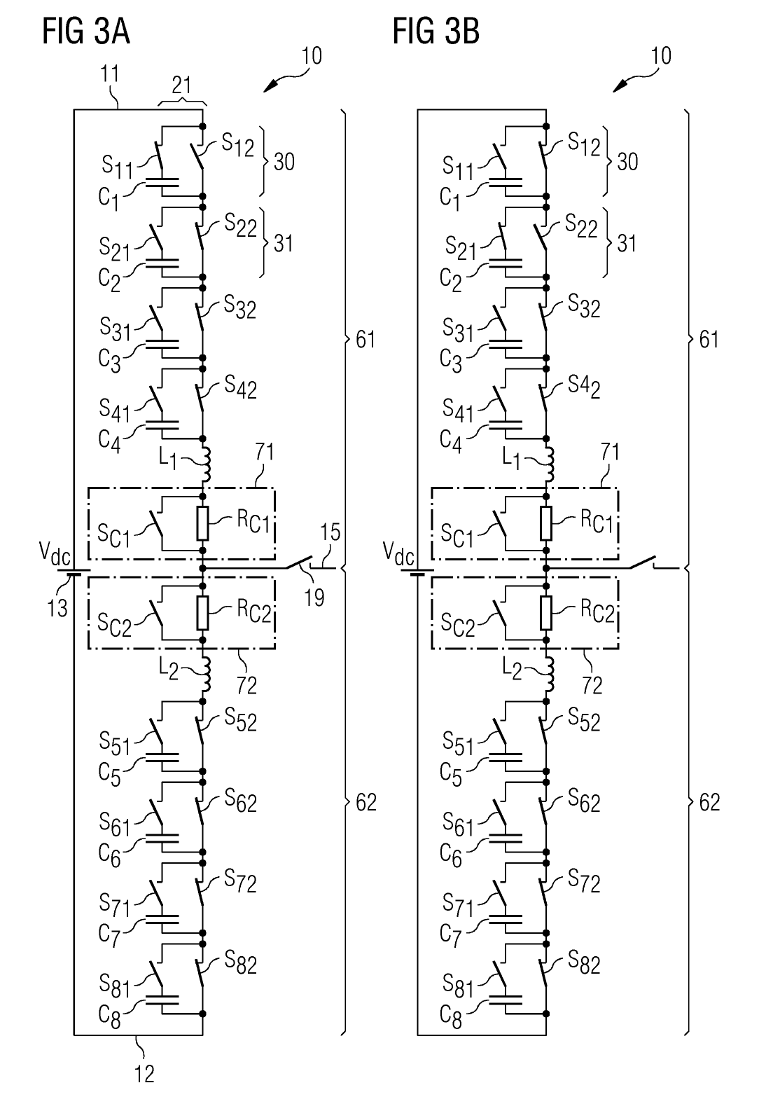

With respect to FIGS. 1 and 2, the general operation and configuration of the converter 10 is described. Modifications of converter 10 in accordance with embodiments of the invention are illustrated and described with respect to the remaining FIGS. 3 to 10. Thus, the explanations given above with respect to FIGS. 1 and 2 are equally applicable to the multilevel converters and methods of starting up such multilevel converter described hereinafter.

FIGS. 3A and 3B illustrate a configuration of the multilevel converter 10 having a single converter leg 21, although it should be clear that further converter legs may be provided. In the upper converter arm (or first converter arm) 61, a resistor circuit 71 is provided while in the lower converter arm (or second converter arm) 62, a resistor circuit 72 is provided. Each resistor circuit 71, 72 comprises a resistance R_{C1}/R_{C2} and a switch S_{C1}/S_{C2} respectively. The resistor circuits 71, 72 are provided for enabling the charging of the capacitors C₁-C₈ of the converter cells at start up of the multilevel converter 10 from the main power source, i.e. either the DC power source or the AC power source connected to the converter.

The switch S_{C1}/S_{C2} of the resistor circuit can be a mechanical switch or an electronic switch, e.g. a semiconductor switch. The switching frequency of the switch of the resistor circuit can be relatively low as switching generally occurs only during the charging or discharging of the capacitors of the converter cells. A mechanical contactor may thus be used for this purpose. By appropriately inserting or bypassing the resistance R_{C1}/R_{C2} by means of switch SC₁/SC₂, respectively, the capacitors in the converter cells can be charged to the desired voltage level. The resistance of the resistor circuits is also used if the capacitors need to be discharged, e.g. for the removal of a converter cell from the circuit. This may for example be necessary if a converter cell needs to be exchanged. During general operation, i.e. steady state operation of the multi level converter 10, the resistance R_{C1}/R_{C2} of the respective resistor circuits can be bypassed by closing the switch S_{C1} and S_{C2}, respectively.

Note that FIGS. 3A and 3B illustrate the same multilevel converter 10, wherein FIG. 3A illustrates a switching state in which capacitor C₁ is charged, whereas FIG. 3B illustrates a switching state in which the capacitor C₂ is charged.

In the present embodiment, the capacitors of the converter cells 30, 31, . . . are charged from the main voltage source. For applications in which the converter is used for supplying power to a drive, the main voltage source may be provided by a DC Bus of a rectifier system. DC terminals 11 and 12 can be coupled to the positive and negative (or ground, GND) DC Bus poles.

In the example of FIG. 3, the upper and lower converter arms of the single AC phase have each four converter cells. Initially, at start up of the multilevel converter 10, all the converter cells are discharged and the load is disconnected, e.g. by switch 19. The switches S_{C1} and S_{C2} of the resistor circuits 71, 72 are opened, as illustrated in FIG. 3A. In the figure, Sₘₙ denotes the switches of the converter cells, wherein “m” indicates the cell number (m=1 to 8) and “n” denotes the switch in each cell (n=1 or 2, as illustrated in FIG. 2). In FIG. 3A, the topmost capacitor C₁ is charged. For this purpose, switch S₁₁ of converter cell 30 is closed and switch S₁₂ is opened. In the remaining converter cells, the switches Sₘ₂ (m=2 to 7) are closed. The remaining cells m=2 to 8 are thus essentially bypassed. Accordingly an RLC circuit is formed (including inductances L1 and L2), and the capacitor C₁ is charged to the DC Bus voltage V_{dc}.

Generally, it is only required to charge the capacitor to a voltage level of V_{dc/4}. By means of e.g. a voltage sensor provided in the converter cell which measures the charging state of the capacitor, it can be determined when this voltage level is reached, in response to which the switch S₁₁ is opened and the switch S₁₂ is closed (as illustrated in FIG. 3B). Capacitor C₁ is thus charged to the desired level and taken out of the circuit.

At the same time or with a short delay after taking out C₁, the capacitor C₂ of converter cell 31 can be inserted into the circuit by closing switch S₂₁ and opening switch S₂₂ (see FIG. 3B). A RLC circuit similar to the one mentioned above is thus formed, as the resistance and capacitance values in the RLC circuit are essentially equal. The second capacitor C₂ is thus also charged through the resistances R_{C1} and R_{C2} of the resistor circuits 71 and 72.

This charging process can be repeated until all the capacitors in the upper and lower converter arms 61, 62 are charged to V_{dc/4}. The capacitors of the converter cells in further converter legs can be charged with a corresponding process. For a 3-phase converter, converter legs 21, 22 and 23, as illustrated in FIG. 1, may for example be energized, wherein the charging of the capacitors of different converter legs can occur simultaneously.

In the example of FIG. 3, the upper and lower converter arms 61 and 62 are essentially symmetric, with a resistor circuit 71 and 72 being provided in each converter arm. It should be clear that other configurations are also conceivable. As an example, only one resistor circuit may be provided, through which the capacitor of each converter cell can be charged. The complexity may thus be further reduced. On the other hand, providing two resistor circuits 71, 72 can be advantageous for discharging the capacitor of a particular converter cell or for charging the capacitor of a converter cell from the AC terminal 15. The charging in FIGS. 3A and 3B occurs from the DC side, yet as will be illustrated further below, the charging is also possible from the AC side (terminal 15). It should furthermore be clear that each converter arm 61, 62 may comprise more or fewer converter cells, and that the capacitors of each converter cell may be charged to different voltage levels.

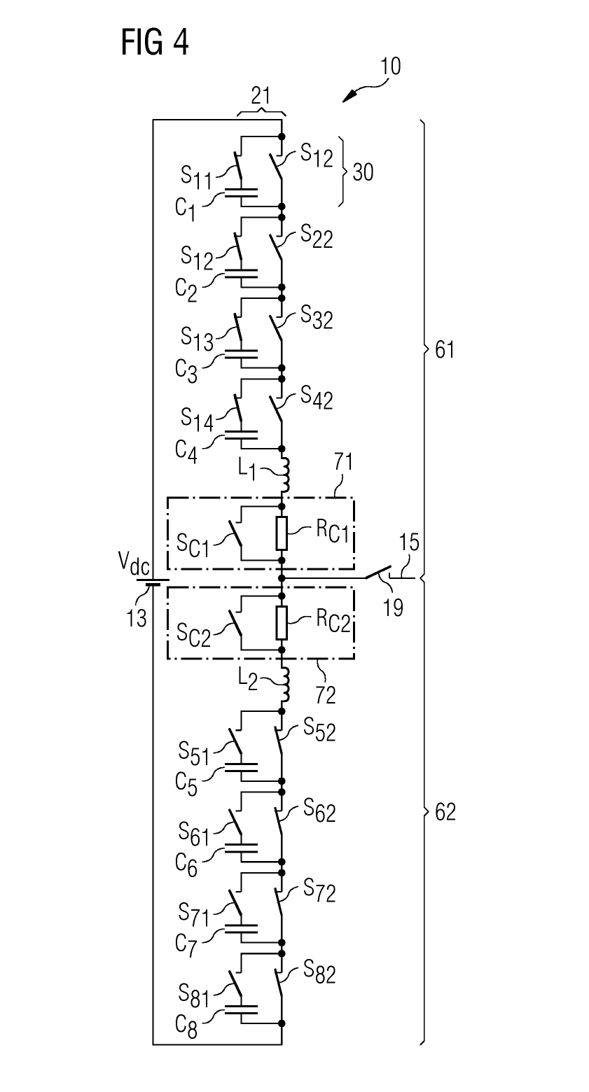

FIG. 4 again illustrates the multilevel converter 10 of FIGS. 3 and 3B. In FIG. 4, the charging of the capacitors occurs with a method in accordance with another embodiment of the invention. In FIG. 4, the capacitors of the converter cells can be charged without the need for obtaining the charging level of the capacitors by means of a voltage sensor. In the example of FIG. 4, all capacitors of the upper converter arm 61 are charged simultaneously. As illustrated, all switches Sᵢ₁ (i=1 to 4) are closed in the upper converter arm 61, and the switches Sᵢ₂ (i=5 to 8) in the lower converter arm 62 are closed so that the lower converter cells are bypassed. Thus, each of the capacitors in the upper converter arm 61 is charged to a voltage of V_{dc/4}, yet the charging occurs with a different time constant compared to a single capacitor.

The capacitors of the converter cells of the lower converter arm 62 can be charged correspondingly by closing the switchers Sᵢ₂ of the upper converter arm and the switches Sᵢ₁ of the lower converter arm. The remaining switches of the converter cells are opened. This method can be performed with any number of converter cells in each converter arm, the capacitor of each converter cell then being charged to a voltage of V_{dc/n} wherein n denotes the number of converter cells in the converter arm.

In dependence on the values of the resistance R, the inductance L and the capacitance C of the capacitor, the series RLC circuit can have an under-damped response. This may cause currents to flow into the DC Bus, which is generally undesirable. Accordingly, the resistance R of the resistor circuit may be adjusted so as to achieve an over-damped response of the RLC circuit. The selection of the resistance for achieving the over-damped response is outlined in detail further below. This can ensure that energy is always drawn from the DC power source during the charging process.

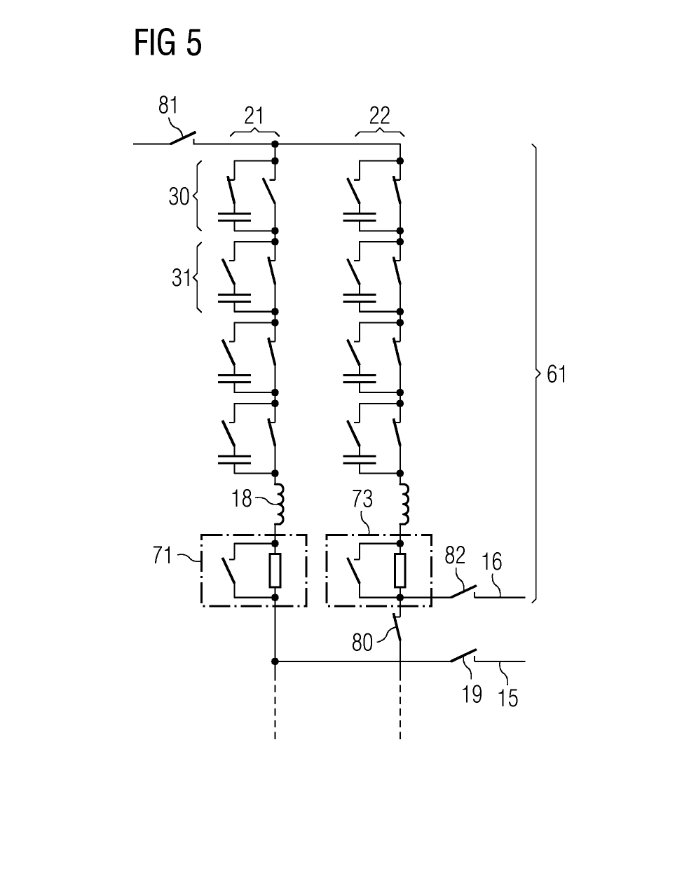

In the configuration of the multilevel converter 10 in accordance with the above described embodiment, it is also possible to selectively discharge the capacitors of the converter cells. This is illustrated in FIG. 5. Two converter arms 21 and 22 of the multilevel converter 10 for two different AC phases are illustrated in FIG. 5. By closing a switch 80, the upper converter arms of both converter legs 21 and 22 are shorted. The electrical links 41 and 42 (as illustrated in FIG. 1) are electrically connected to each other. By opening the switches (or breakers) 19, 82 and 81, both the AC or DC power supply and the DC or AC load, respectively, are separated from the multilevel converter 10 (i.e. the DC and AC side breakers are opened). As the operation of the multilevel converter 10 ceases, the capacitors may still be charged to a voltage of a bout V_{dc/4}. The capacitor to be discharged is now inserted into the circuit by means of switches S₁ and S₂ of the respective converter cell, while all the other converter cells are bypassed. In the example of FIG. 5, the capacitor of converter cell 30 is inserted into the circuit and is discharged through the inductances 18, and the resistor circuits 71 and 73. The AC circuit formed this way may be over-damped or under-damped, the capacitor being discharged in both cases.

Note that FIG. 5 only illustrates the upper converter arms of multilevel converter 10, the lower converter arms not being shown for the purpose of a comprehensive presentation.

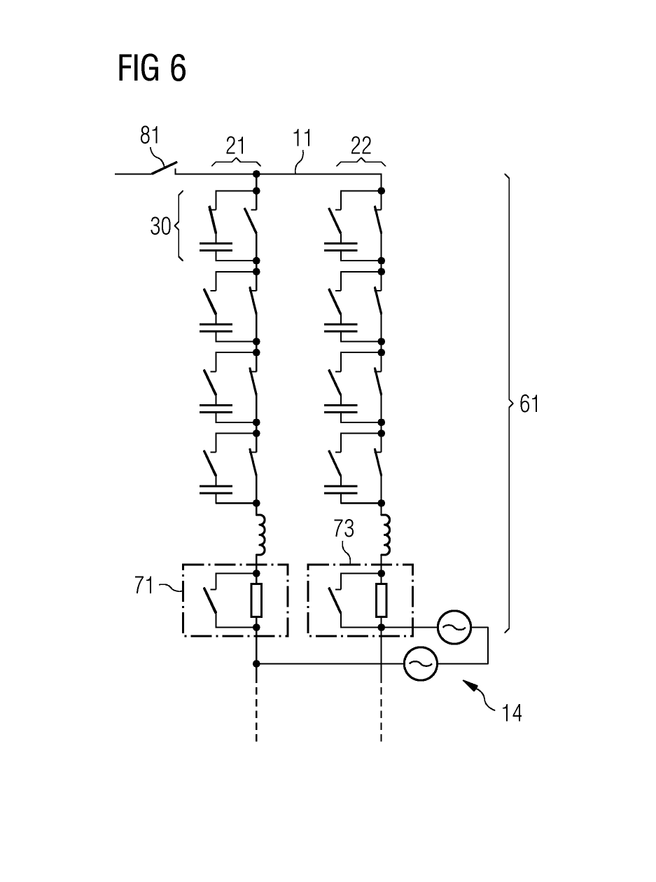

As mentioned above, it is also conceivable to charge the capacitors of the converter cells of the multilevel converter 10 from an AC power source connected thereto, as illustrated in FIG. 6. This may for example be performed for converters in a HVDC (high voltage DC) application in which the converter generates a DC voltage that is to be transmitted over a DC transmission line. The converter thus acts as an AC-DC rectifier and the AC voltage source is available for charging. Again, FIG. 6 only illustrates the two upper arms of two converter legs 21, 22. Two phases of the AC power source connected to the respective converter legs are shown. The capacitor of the cell which is to be charged is now inserted into the circuit. All other cells are bypassed. Depending on the instant when the AC voltage is applied to the capacitor, the capacitor voltage rises to the desired level. The capacitor may for example be charged during a leading edge of the AC voltage waveform. Using the above mentioned voltage sensor, the level to which the capacitor is charged can be determined, and the capacitor can be taken out of the circuit when reaching a voltage level of V_{dc/n}. This can be repeated for the remaining converter cells so that the capacitor of each converter cell can be charged. Attention has to be paid on the polarity of the capacitor when charging from the AC power source.

As can be seen, in the examples outlined above, the capacitors of the converter cells can be directly charged from the DC or AC power source, without requiring an auxiliary voltage source for charging. This is achieved by making use of the resistor circuits using which the resistance can be inserted or taken out (bypassed) of the converter leg. In the following, it will be explained how an over-damped RLC circuit is obtained for avoiding currents flowing into the power source.

In case of a series RLC circuit fed from a dc voltage source, the governing differential equation is:

$${V}_{dc} = Ri ( t ) + L \frac{d i ( t )}{d t} + \frac{1}{C} \int i ( t ) d t \qquad ( 1 )$$

wherein R is the resistance, i(t) is the time (t) dependent current through the circuit and d/dt is the time derivative. For obtaining an over-damped response of this second order differential equation, the damping factor ξ>1 can be chosen, wherein the following parameters are defined:

ξ=α/ω₀ (2)

α=R/2L (3)

ω₀=1/\sqrt{LC} (4)

The solution to this equation for zero initial conditions is given by

$$i ( t ) = \frac{{V}_{dc}}{2 L {ω}_{0} \sqrt{{ξ}^{2} - 1}} \{ {e}^{- {ω}_{0} ( ξ - \sqrt{{ξ}^{2} - 1} ) t} - {e}^{- {ω}_{0} ( ξ + \sqrt{{ξ}^{2} - 1} ) t} \} \qquad ( 5 )$$

It is useful to define the following two terms:

α₁=ω₀(ξ+\sqrt{ξ²−1}) (6)

α₂=ω₀(ξ−\sqrt{ξ²−1}) (7)

The peak value of the current (iₚₑₐₖ) can be obtained by differentiating (5) with respect to time. Thus,

$${i}_{peak} = \frac{{V}_{dc}}{2 L {ω}_{0} \sqrt{{ξ}^{2} - 1}} \{ {e}^{- {α}_{2} {t}_{peak}} - {e}^{- {α}_{1} {t}_{peak}} \} \qquad ( 8 )$$

where, tₚₑₐₖ is the time instant when this peak current occurs.

$${t}_{peak} = \frac{ln ( {α}_{1} / {α}_{2} )}{{α}_{1} - {α}_{2}} \qquad ( 9 )$$

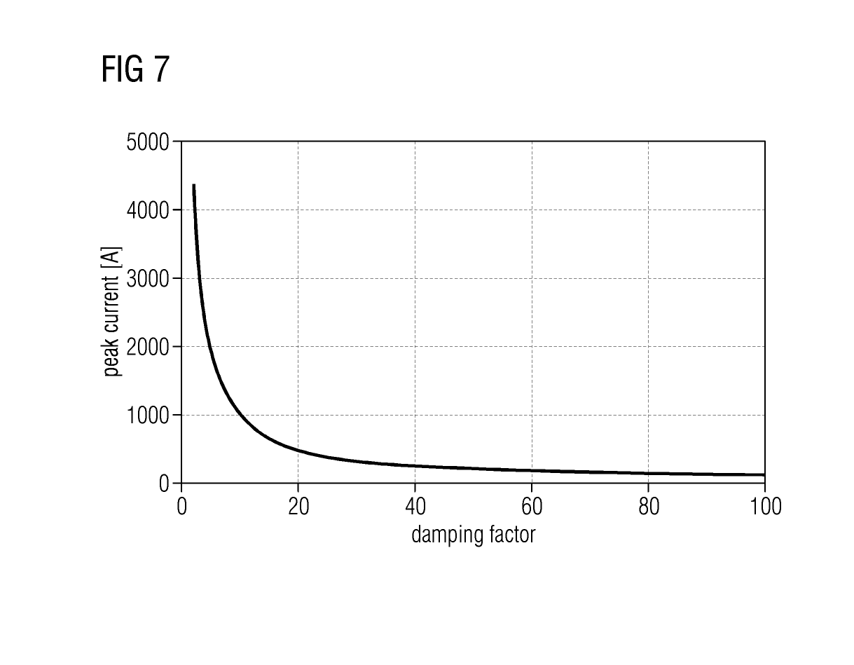

A plot of iₚₑₐₖ with variation in ξ following eqn. (8) is shown in FIG. 7 where (V_{dc}/2Lw₀) is calculated from the values shown in Table 1. It shows that for values of ξ close to unity, the peak current rises very sharply. However, for ξ equal to 20 or higher, the peak current does not change very much. This parameter can be used to limit the charging current in the converter and will be used for selecting the values of R as described hereinafter.

TABLE I

| Parameters | Value | Parameters | Value | |
|---|---|---|---|---|
| Rated line-line | 6.6 kV | DC link voltage | 10 | kV |
| voltage | | V_{dc} | | |
| Rated current | 583 A | Maximum modulation | 0.54 | |
| | | index | | |
| Rated power | 6 MW | Number n of cells | 4 | |
| | | in each arm | | |
| Rated power factor | 0.9 | Arm inductance | 1 | mH |
| Rated frequency | 50 Hz | Cell capacitance | 8 | mF |

Table 1 shows some of the circuit parameters of a 6.6 kV, 6 MW MMC in accordance with an embodiment of the invention that is adapted for a drives application. The values of capacitance of the capacitor of the converter cells and arm inductance give good performance at steady state condition (during normal operation). The resistance of the resistor circuit of the converter arm can be selected for this converter as follows. It is assumed that the charging current will be limited to 500 A (this can certainly be varied for different embodiments). From FIG. 7, a damping factor of 20 can be selected for achieving this maximum current. From eqns. (2), (3) and (4), the value of the resistance in the converter arm can be determined to 10 ohms. During discharge of the converter cell as illustrated in FIG. 5, the peak discharge current is limited to V_{dc}/(8R) which is equal to 125 A and is an acceptable value.

For the case shown in FIG. 4, where the capacitors of a converter arm are charged simultaneously, the equivalent series capacitance of the converter arm is 2 mF. A curve similar to FIG. 7 can be determined for this case (not shown), and the required damping factor can be determined. The value of the resistance of the resistor circuit in the converter arm can thus be determined to 10 ohms.

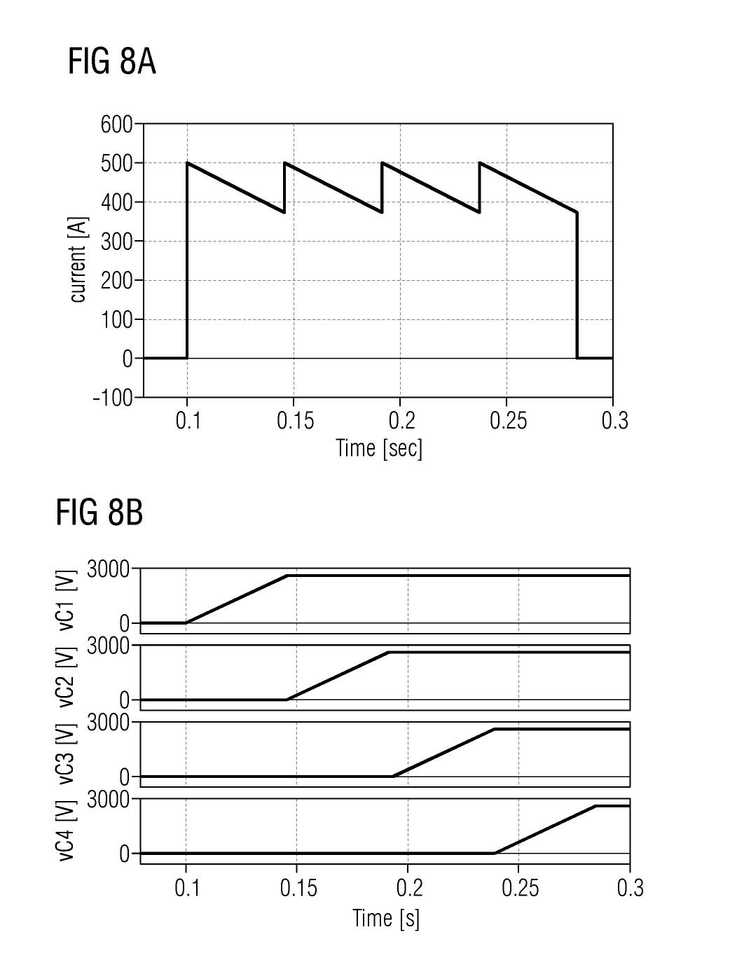

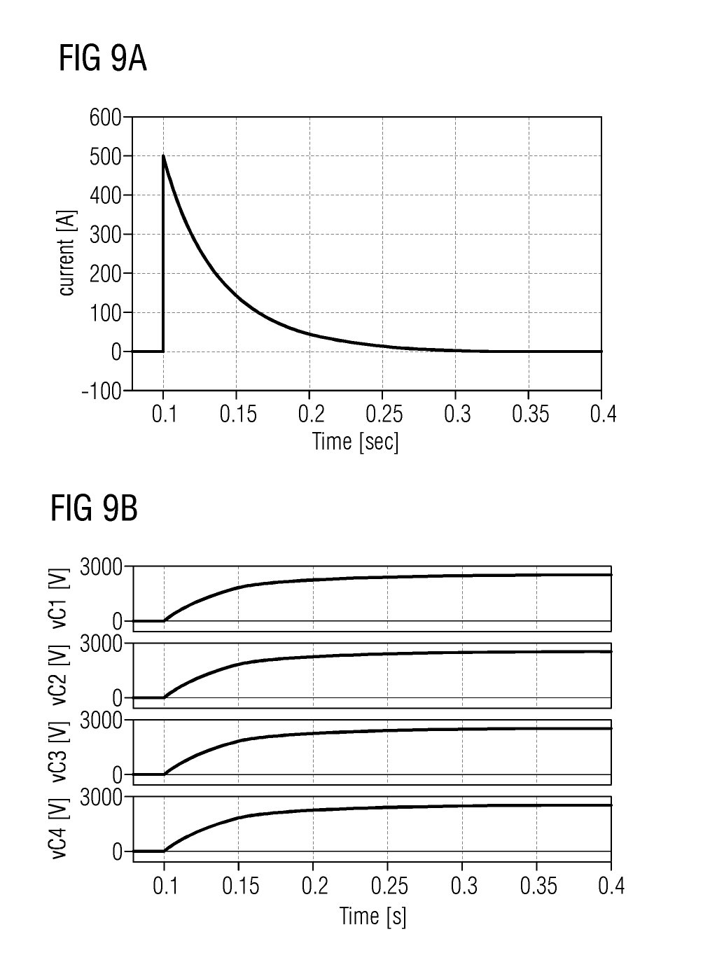

Two simulation results for charging the capacitors in a converter arm individually or simultaneously are illustrated in FIGS. 8 and 9. In FIGS. 8A and 8B, the charging method as outlined with respect to FIG. 3 is followed. FIG. 8A shows the charging current flowing in a converter arm. At t=0.1 s, the DC side breaker (e.g. breaker 81) is closed and the top capacitor C1 is charged towards V_{dc}. Once the voltage on the top capacitor C₁ reaches 2.5 kV, the capacitor is disconnected. The second and subsequently all other capacitors in the arm are charged sequentially (FIG. 8B). Once all the four capacitors are charged, all Sᵢ₁ (i=1 to 4) are closed and the complementary switches are opened. This will immediately bring the current in the circuit to zero. At this condition, the DC side breaker can be opened easily. This completes the charging process for one converter arm. The remaining converter arms may be charged correspondingly.

FIGS. 9A and 9B show the case in which all the capacitors of a converter arm are charged simultaneously without making use of a voltage sensor. This is similar to the previous case. The DC side breaker 81 can be safely opened once the charging current dies down to zero.

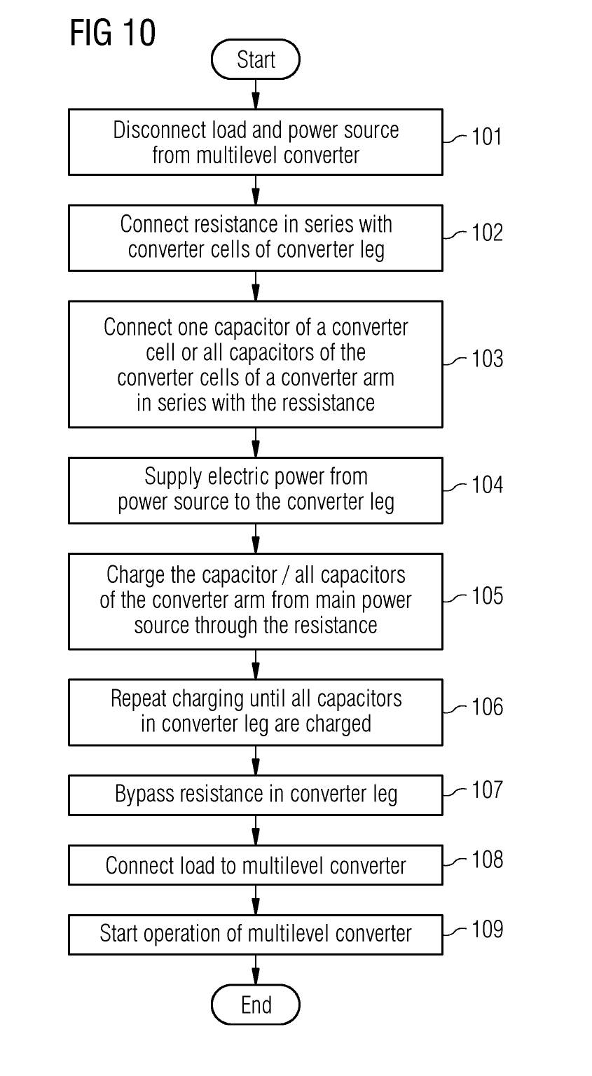

FIG. 10 shows a flow diagram of a method according to an embodiment of the invention that may be performed by any of the above mentioned multilevel converters 10. In step 101, the load and the power source are disconnected from the multilevel converter. In step 102, a resistance is connected in series with the converter cells of a converter leg. For example the resistances R_{C1} and R_{C2} may be inserted into the circuit of converter leg 21 by opening the switches S_{C1} and S_{C2} of the respective resistor circuits. Otherwise, the resistances are bypassed when these switches are closed.

In step 103, the capacitor of a converter cell or the capacitors of all converter cells of a converter arm are connected in series with the resistance, as for example described with respect to FIG. 3 or 4. This can be done by appropriately switching the switches S₁ and S₂ of the converter cells.

In step 104, electric power is supplied to the multilevel converter, e.g. by connecting an AC or DC power source thereto. This can for example be achieved by closing the switch/breaker 19 or 81, respectively. The capacitor/all capacitors of the converter arm that are connected in series with the resistor are charged from the connected main power source through the resistance in step 105. The charging is repeated for all the capacitors in the converter leg (step 106), e.g. by charging each capacitor separately or by charging the second converter arm at once.

Corresponding steps can certainly be repeated for further converter legs, if such are provided in the multilevel converter. The multilevel converter is now energized and can start normal operation. For this purpose, the resistance in the converter leg is bypassed (step 107), e.g. by closing the switch of the respective resistor circuit. In step 108, the load is connected to the multilevel converter (e.g. an AC drive of a DC transmission line), whereafter the operation of the multilevel converter is started (step 109). The multilevel converter can now operate in steady state.

When stopping the operation of the multilevel converter, the converter cells can be de-energized as outlined above by discharging the capacitor of the converter cell via the converter arms of two converter legs and through the resistance which is again inserted into the respective converter leg for this purpose.

Embodiments disclosed herein thus provide methods for charging and discharging the capacitances of a multilevel converter, in particular a modular multilevel converter. It should be clear that the features of the embodiment described above may be combined. The charging does not require any auxiliary voltage source. In case of drives application, the DC bus can be used to charge the capacitances of the converter cells. By inserting a resistance into the converter leg and adjusting its value, the capacitors of the converter cells can be charged to the desired voltage level. The additional resistance can be bypassed under normal operating conditions.

1. A multilevel converter for converting between an AC voltage and a DC voltage, the multilevel converter (10) having an AC terminal (15) and a DC terminal (11, 12) for connecting the multilevel converter to either an AC power source (14) or a DC power source (13), respectively, which supplies the voltage to be converted, wherein the multilevel converter (10) comprises:
at least one converter leg (21), the DC terminal comprising a first DC terminal (11) and a second DC terminal (12), the converter leg (21) comprising plural converter cells (30, 31, 32) connected in series between the first and second DC terminals (11, 12), wherein the AC terminal (15) of the multilevel converter is electrically coupled to an electrical link (41) between two of said converter cells (30, 31, 32) of said converter leg (21), and
a resistor circuit (71, 72) comprised in said converter leg (21) and connected in series with said converter cells (30, 31, 32), the resistor circuit (71, 72) being configured so as to be capable of connecting a resistance (R_{C1}, R_{C2}) in series with the converter cells (30, 31, 32) of the converter leg (21),
wherein each converter cell (30, 31, 32) comprises a capacitor (55), the multilevel converter (10) being configured so as to enable a charging of the capacitor (55) of a converter cell (30, 31, 32) from the power source connected to the AC terminal (15) or the DC terminal (11, 12) of the multilevel converter through the resistance of the resistor circuit (71, 72).

2. The multilevel converter according to claim 1, wherein the resistor circuit (71, 72) comprises said resistance (R_{C1}, R_{C2}) connected in series with the converter cells, the resistor circuit further comprising a switch (S_{C1}, S_{C2}) connected in parallel with said resistance (R_{C1}, R_{C2}) so as to enable a bypassing of the resistance (R_{C1}, R_{C2}) by closing the switch (S_{C1}, S_{C2}).

3. The multilevel converter according to claim 2, wherein the switch (S_{C1}, S_{C2}) is a mechanical switch, an electronic switch or a semiconductor switch.

4. The multilevel converter according to claim 1, wherein the converter leg (21) comprises a first converter arm (61) comprising the converter cells (30, 31) coupled between the first DC terminal (11) and the electrical link (41) and a second converter arm (62) comprising the converter cells (32, 33) coupled between the second DC terminal (12) and the electrical link (41), wherein the resistor circuit (71) is comprised in the first converter arm (61), the second converter arm (62) further comprising a second resistor circuit (72) connected in series with the converter cells (32, 33) of the second converter arm (62).

5. The multilevel converter according to claim 1, wherein the multilevel converter (10) is adapted so as to be capable of discharging the capacitor (55) of a converter cell (30, 31, 32) through the resistance (R_{C1}, R_{C2}) of the resistor circuit (71, 72).

6. The multilevel converter according to claim 1, further comprising a switch (80) to connect the AC terminal (15) of a first of the converter legs (21) to a second AC terminal (16) of a second of the converter legs (22) so as to enable the discharging of the capacitor (55) of a converter cell through at least part of the first and the second converter legs (21, 22).

7. The multilevel converter according to claim 1, wherein the converter leg (21) further comprises an inductance (18) connected in series with the converter cells (30, 31, 32), the resistance of the resistor circuit (71, 72) being configured such that the series connection of the inductance (18), the resistance (R_{C1}, R_{C2}) and the capacitor (55) of one converter cell (30) or of the converter cells (30, 31) connected between the first or second DC terminal (11, 12) and the electrical link (41) provide an overdamped system.

8. The multilevel converter according to claim 1, wherein each converter cell comprises two terminals (56, 57) by which the converter cell (30) is connected in series with the other converter cells (31, 32) in the converter leg (21), the converter cell comprising a first switch (S₁) and a second switch (S₂), the second switch (S₂) being connected in series with the capacitor (55) of the converter cell, the first switch (S₁) being connected in parallel with the capacitor (55) and the second switch (S₂) of the converter cell (30).

9. The multilevel converter according to claim 1, wherein the converter leg (21) comprises a first converter arm (61) comprising the converter cells (30, 31) coupled between the first DC terminal (11) and the electrical link (41) and a second converter arm (62) comprising the converter cells (32, 33) coupled between the second DC terminal (12) and the electrical link (41), and
wherein the multilevel converter is configured so that by closing all first switches of the converter cells in the second converter arm and by opening all first switches (Sᵢ₁) and closing all second switches (Sᵢ₂) of the converter cells in the first converter arm (61), the capacitor (55) of each converter cell in the first converter arm (61) can be charged through the resistance.

10. A method of starting up a multilevel converter, the multilevel converter (10) being adapted to convert between an AC voltage and a DC voltage, the multilevel converter having an AC terminal (15) and a DC terminal (11, 12) for connecting the multilevel converter to either an AC power source (14) or a DC power source (13), respectively, which supplies the voltage to be converted, the multilevel converter comprising a converter leg (21) with plural converter cells (30, 31, 32) connected in series, each converter cell comprising a capacitor (55), the method comprising the steps of
supplying electric power of the AC power source or the DC power source to the converter leg (21),
connecting a resistance (R_{C1}, R_{C2}) in series with the converter cells (30, 31, 32), and
connecting the capacitor (55) of one or more converter cells (30, 31) in series with the resistance (R_{C1}, R_{C2}),
wherein the one or more capacitors (55) connected in series with the resistance are charged from the connected power source (13, 14) through the resistance (R_{C1}, R_{C2}).

11. The method according to claim 10, wherein the step of connecting the capacitor (55) of one or more converter cells (30, 31, 32) in series with the resistance (R_{C1}, R_{C2}) so as to charge the one or more capacitors through the resistance is repeated until the capacitor of each converter cell in the converter leg (21) is charged.

12. The method according to claim 10, wherein the converter leg (21) comprises a first converter arm (61) comprising the converter cells (30, 31) coupled between the first DC terminal (11) and the electrical link (41) and a second converter arm (62) comprising the converter cells (32, 33) coupled between the second DC terminal (12) and the electrical link (41),
wherein the step of connecting the capacitor (55) of one or more converter cells in series with the resistance (R_{C1}, R_{C2}) comprises connecting the capacitor (55) of each converter cell in the first or second converter arm (61, 62) in series with the resistance (R_{C1}, R_{C2}), so that each of the capacitors (55) of the respective converter arm (61, 62) is charged through the resistance (R_{C1}, R_{C2}) from the connected power source.

13. The method according to claim 10, wherein at the DC terminal (11, 12) of the multilevel converter, a predetermined DC voltage is supplied by a DC power source or is to be supplied to a DC load, wherein the converter leg (21) comprises a first converter arm (61) comprising the converter cells (30, 31) coupled between the first DC terminal (11) and the electrical link (41) and a second converter arm (62) comprising the converter cells (32, 33) coupled between the second DC terminal (12) and the electrical link (41),
wherein for each converter arm (61, 62), the capacitor of each converter cell of the converter arm is charged to a voltage that is about equal to the predetermined DC voltage (V_{dc}) divided by the number of converter cells (n) comprised in the respective converter arm (61, 62).

14. The method according to claim 10, wherein the at least one converter leg comprises a first converter leg (21) for a first phase of the AC voltage and a second converter leg (22) for a second phase of the AC voltage, the first and second converter legs being connected in parallel between the first and second DC terminals (11, 12) of the multilevel converter, the method further comprising
connecting a first phase of the AC power supply to the AC terminal (15) of the first converter leg (21) and connecting a second phase of the AC power supply to an AC terminal (16) of the second converter leg (22),
connecting the capacitor (55) of at least one converter cell (30) of the first converter leg (21) between one DC terminal (11, 12) and an AC terminal (15) of the first converter leg (21),
connecting the resistance (R_{C1}) of the first converter leg (21) in series with the capacitor (55) of the at least one converter cell, and
providing an electrical connection (80) between the AC terminal (16) of the second converter leg and said DC terminal (11, 12) by means of the second converter leg (22),
wherein the at least one capacitor (55) is charged from the AC power source (14) via at least part of the first and second converter legs (21, 22).

15. A method of discharging a capacitor (55) of a multilevel converter (10), the multilevel converter being adapted to convert between an AC voltage and a DC voltage, the multilevel converter comprising at least a first and a second converter leg (21, 22) each being connected between a first DC terminal (11) and a second DC terminal (12) of the multilevel converter (10), wherein each the converter legs (21, 22) comprises plural converter cells (30, 31, 32) connected in series between the first and second DC terminals (11, 12), each converter cell comprising a capacitor (55), the method comprising the steps of
disconnecting the power source and a load from the multilevel converter (10),
connecting the capacitor (55) of a converter cell (30, 31, 32) comprised in one of the converter legs (21, 22) in series with the converter cells of the converter leg,
connecting a resistance (R_{C1}, R_{C2}) in series with the capacitor (55) of the converter cell (30, 31, 32), and
providing an electrical connection (80) between the first and second converter legs (21, 22) such that the capacitor (55) is discharged through the resistance (R_{C1}, R_{C2}), at least a part of the first and second converter legs (21, 22), and said electrical connection (80).
